(19) United States
(12) Patent Application Publication
(10) Pub. No.: US 2012/0328833 A1
(43) Pub. Date: Dec. 27, 2012

(54) Double-face Antiskid Mat

(76) Inventor: Chien-Hsin Chao, Xiushui Township (TW)

(21) Appl. No.: 13/165,840

(22) Filed: Jun. 22, 2011

(51) Int. Cl. B32B 3/30

(52) U.S. Cl. 428/156

(57) ABSTRACT

An antiskid mat includes a mat body having a front face and a rear face. Each of the front face and the rear face of the mat body is provided with a plurality of convex portions and a plurality of concave portions. Thus, each of the concave portions of the mat body is compressed and restored to produce a vacuum suction force so that each of the concave portions of the mat body is attached to the object closely and exactly so as to provide an antiskid effect to the user.

### BACKGROUND OF THE INVENTION

1. Field of the Invention

The present invention relates to a foot mat and, more particularly, to a double-face antiskid mat.

2. Description of the Related Art

A conventional antiskid mat comprises a mat body having a face provided with a plurality of protrusions to provide an antiskid effect to a user. However, only one face of the mat body has the protrusions, thereby limiting the antiskid effect of the antiskid mat. In addition, the antiskid mat is usually hard so that it easily causes an uncomfortable sensation to the user. Further, the antiskid mat does not have an antibacterial or germproof effect. Further, the antiskid mat is made of plastic material and cannot be decomposed naturally so that the antiskid mat easily pollute the environment when it is worn out and disposed of.

### BRIEF SUMMARY OF THE INVENTION

In accordance with the present invention, there is provided an antiskid mat, comprising a mat body having a front face and a rear face. Each of the front face and the rear face of the mat body is provided with a plurality of convex portions and a plurality of concave portions.

Each of the convex portions of the front face of the mat body aligns with a respective one of the concave portions of the rear face of the mat body. Each of the concave portions of the front face of the mat body aligns with a respective one of the convex portions of the rear face of the mat body. The mat body is made of a resilient material. The mat body is made of rubber. Each of the convex portions of the mat body is provided with a particle. The particle of each of the convex portions is located at a distal end of each of the convex portions. The mat further comprises an additive mounted in the mat body to provide an antibacterial or germproof effect to the mat body. The additive is a modified starch and resin. The convex portions and the concave portions of the front face of the mat body are arranged in a staggered manner. The convex portions and the concave portions of the rear face of the mat body are arranged in a staggered manner.

According to the primary advantage of the present invention, each of the concave portions of the mat body is compressed and restored to produce a vacuum suction force so that each of the concave portions of the mat body is attached to the object closely and exactly so as to provide an antiskid effect to the user.

According to another advantage of the present invention, each of the front face and the rear face of the mat body is provided with a plurality of convex portions and a plurality of concave portions so that the mat body can provide a double-face antiskid effect to the user.

According to a further advantage of the present invention, an additive is mounted in the mat body to provide an antibacterial or germproof effect to the mat body.

According to a further advantage of the present invention, the mat body can be thrown away or disposed of by provision of the additive so that the mat body will not pollute the environment when it is worn out.

According to a further advantage of the present invention, the particle of each of the convex portions provides a massaging effect to the user's foot.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front perspective view of an antiskid mat in accordance with the preferred embodiment of the present invention.

FIG. 2 is a rear perspective view of the antiskid mat in accordance with the preferred embodiment of the present invention.

FIG. 3 is a top cross-sectional view of the antiskid mat as shown in FIG. 1.

FIG. 4 is a top cross-sectional view of the antiskid mat as shown in FIG. 2.

FIG. 5 is a schematic cross-sectional operational view of the antiskid mat as shown in FIG. 1 in use.

FIG. 6 is a schematic cross-sectional operational view of the antiskid mat as shown in FIG. 1 in use.

### DETAILED DESCRIPTION OF THE INVENTION

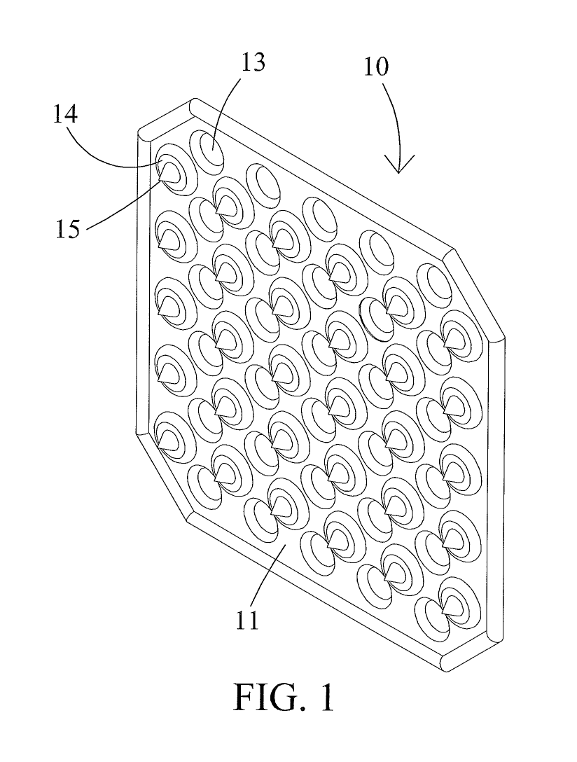

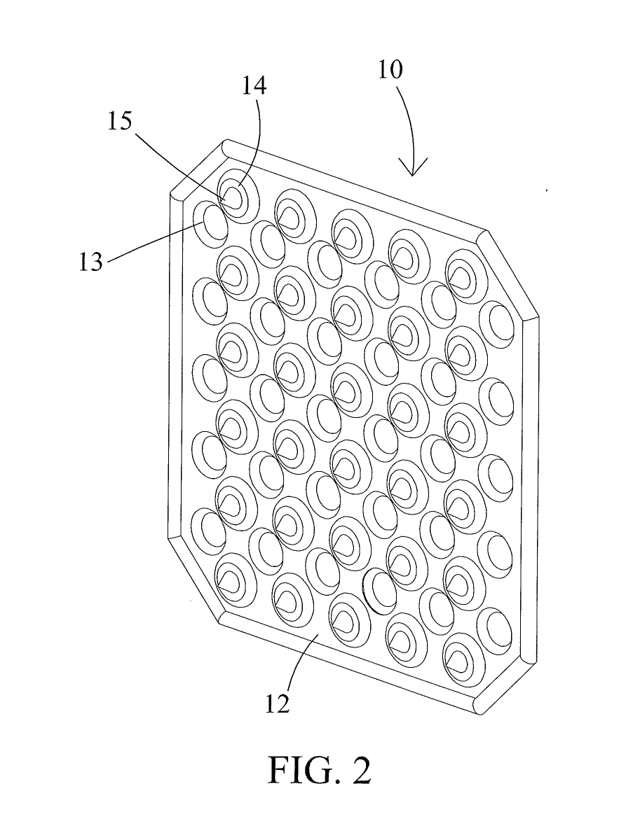

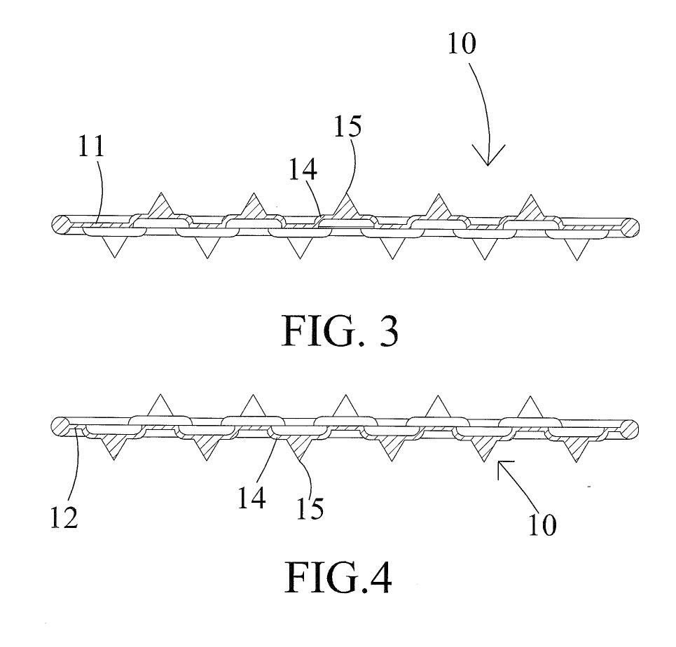

Referring to the drawings and initially to FIGS. 1-4, an antiskid mat in accordance with the preferred embodiment of the present invention comprises a mat body 10 having a front face 11 and a rear face 12.

The mat body 10 is made of a resilient material. Preferably, the mat body 10 is made of rubber. Each of the front face 11 and the rear face 12 of the mat body 10 is provided with a plurality of convex portions 14 and a plurality of concave portions 13. Each of the convex portions 14 of the mat body 10 is provided with a particle 15. Preferably, the particle 15 of each of the convex portions 14 is located at a distal end of each of the convex portions 14. Each of the convex portions 14 of the front face 11 of the mat body 10 aligns with a respective one of the concave portions 13 of the rear face 12 of the mat body 10. Each of the concave portions 13 of the front face 11 of the mat body 10 aligns with a respective one of the convex portions 14 of the rear face 12 of the mat body 10. The convex portions 14 and the concave portions 13 of the front face 11 of the mat body 10 are arranged in a staggered manner. The convex portions 14 and the concave portions 13 of the rear face 12 of the mat body 10 are also arranged in a staggered manner.

In the preferred embodiment of the present invention, the antiskid mat further comprises an additive mounted in the mat body 10 to provide an antibacterial or germproof effect to the mat body 10. Preferably, the additive is a modified starch and resin. In addition, the mat body 10 can be thrown away or disposed of by provision of the additive.

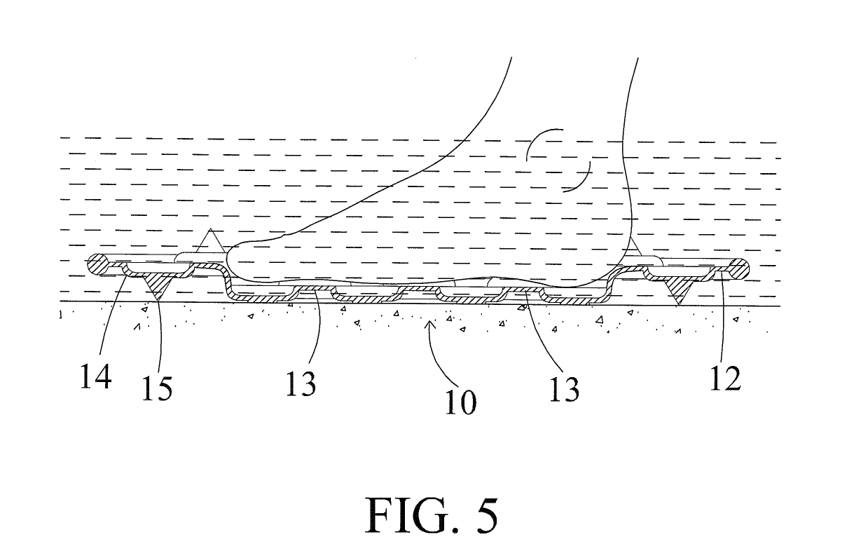

Referring to FIG. 5 with reference to FIGS. 1-4, the mat body 10 is placed on the bottom of an object, such as a bath tub, a swimming pool and the like. In such a manner, when a user's foot treads the mat body 10, each of the concave portions 13 of the mat body 10 is compressed and deformed so that the air in the interior of each of the concave portions 13 of the mat body 10 is drained and evacuated. After the pressing force applied on the mat body 10 is released, each of the concave portions 13 of the mat body 10 is expanded and returned to its original state by the elastic restoring force of the mat body 10 so that the interior of each of the concave portions 13 of the mat body 10 forms a vacuum suction force. Thus, each of the concave portions 13 of the mat body 10 is attached to the object closely and exactly so as to provide an antiskid effect to the user.

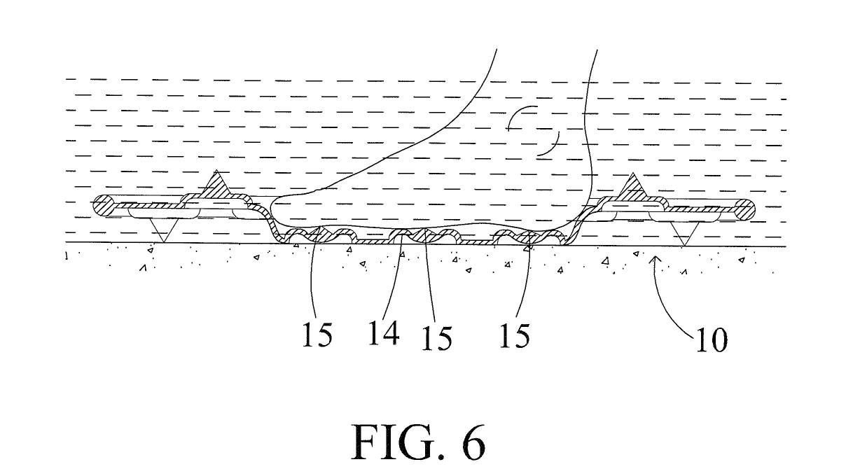

Referring to FIG. 6 with reference to FIGS. 1-4, when the user's foot treads the mat body 10, the particle 15 of each of the convex portions 14 provides a massaging effect to the user's foot.

Accordingly, each of the concave portions 13 of the mat body 10 is compressed and restored to produce a vacuum suction force so that each of the concave portions 13 of the mat body 10 is attached to the object closely and exactly so as to provide an antiskid effect to the user. In addition, each of the front face 11 and the rear face 12 of the mat body 10 is provided with a plurality of convex portions 14 and a plurality of concave portions 13 so that the mat body 10 can provide a double-face antiskid effect to the user. Further, an additive is mounted in the mat body 10 to provide an antibacterial or germproof effect to the mat body 10. Further, the mat body 10 can be thrown away or disposed of by provision of the additive so that the mat body 10 will not pollute the environment when it is worn out. Further, the particle 15 of each of the convex portions 14 provides a massaging effect to the user's foot.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An antiskid mat, comprising:
a mat body having a front face and a rear face;
wherein each of the front face and the rear face of the mat body is provided with a plurality of convex portions and a plurality of concave portions.

2. The antiskid mat of claim 1, wherein
each of the convex portions of the front face of the mat body aligns with a respective one of the concave portions of the rear face of the mat body;
each of the concave portions of the front face of the mat body aligns with a respective one of the convex portions of the rear face of the mat body.

3. The antiskid mat of claim 1, wherein the mat body is made of a resilient material.

4. The antiskid mat of claim 3, wherein the mat body is made of rubber.

5. The antiskid mat of claim 1, wherein each of the convex portions of the mat body is provided with a particle.

6. The antiskid mat of claim 5, wherein the particle of each of the convex portions is located at a distal end of each of the convex portions.

7. The antiskid mat of claim 1, wherein the mat further comprises an additive mounted in the mat body to provide an antibacterial or germproof effect to the mat body.

8. The antiskid mat of claim 7, wherein the additive is a modified starch and resin.

9. The antiskid mat of claim 1, wherein
the convex portions and the concave portions of the front face of the mat body are arranged in a staggered manner;
the convex portions and the concave portions of the rear face of the mat body are arranged in a staggered manner.
